(19) United States
(12) Patent Application Publication
(10) Pub. No.: US 2013/0264328 A1
(43) Pub. Date: Oct. 10, 2013

(54) THERMAL BEVERAGE CONTAINER HOLDER

(71) Applicant: John Ulvr, Kanata (CA)

(72) Inventor: John Ulvr, Kanata (CA)

(21) Appl. No.: 13/440,069

(22) Filed: Apr. 5, 2012

(51) Int. Cl. B65D 85/00; F25D 31/00; H05B 3/02

(52) U.S. Cl. 219/438; 220/592.16; 62/259.1

(57) ABSTRACT

A thermal beverage container holder having a housing; at least one thermal element configured to fit within the housing; and an actuator configured to cause thermal contact between the at least one thermal element and a beverage container.

### FIELD OF THE DISCLOSURE

The present disclosure relates to a beverage container holder and in particular to a beverage container holder capable of heating or cooling the beverage container.

### BACKGROUND

It is often desirable to keep a beverage within a container either cooler or warmer than the ambient temperature around the container. To this end, beverages are often refrigerated or served warm. However, once the beverage has been removed from the heating or cooling source, the temperature of the beverage begins to normalize to the environment around it. In this regard, a beverage may be placed within a thermal beverage container holder. Such thermal beverage container holders are known in the art. Some are merely insulated, while others provide heating or cooling elements. For example, AMERIGON™ Corporation makes a thermal cup holder in which the beverage container is either heated or cooled when placed within the container. In other cases, removable ice packs or sleeves can be placed around the periphery of a beverage container holder and may cool or heat a beverage placed within the holder.

However, air is a particularly poor thermal conductor. In the above solutions, a layer of air is disposed around the beverage container and reduces the efficiency of thermal transfer between the holder and the beverage container.

In other cases, gel packs may be placed around a beverage container and make contact with the beverage container. For example, the gel packs may be shaped as a sleeve and the beverage container fits within the gel pack. However, while the gel pack may provide contact with the beverage container, the insertion and removal of the container into and from the sleeve is difficult due to frictional forces. Also, such solutions assume a single sized beverage container, and may not work efficiently with varied sized beverage containers.

### BRIEF DESCRIPTION OF THE DRAWINGS

The present disclosure will be better understood with reference to the drawings, in which:

FIG. 1 is a top perspective view of a beverage container holder in accordance with one embodiment of the present disclosure;

FIG. 2 is a top perspective view of a beverage container holder in accordance with FIG. 1, in which a beverage container has been inserted;

FIG. 3 is a top plan view of a beverage container holder in accordance with the embodiment of FIG. 1;

FIG. 4A is a side elevational view of a mechanical actuator in accordance with one embodiment of the present disclosure prior to actuation;

FIG. 4B is a side elevational view of the mechanical actuator of FIG. 4A after actuation;

FIG. 5 is an alternative embodiment in which an electronic actuator is utilized instead of a mechanical actuator;

FIG. 6 is a side elevational view of a further embodiment of the present disclosure in which the actuator causes a seal to close, and engages a moving fluid element.

FIG. 7 is a top perspective view of a thermal pack in accordance with one embodiment of the present disclosure;

FIG. 8 is a top perspective view of a tray to hold a plurality of thermal packs for heating or cooling; and

FIG. 9 is a top perspective view of the tray of FIG. 8 with thermal packs inserted therein.

### DETAILED DESCRIPTION OF THE DRAWINGS

The present disclosure provides a beverage container holder comprising: a housing; at least one thermal element configured to fit within the housing; and an actuator configured to cause thermal contact between the at least one thermal element and a beverage container.

In accordance with one embodiment of the present disclosure, a beverage container holder is provided in which an actuator forces a heating or cooling element into contact with the beverage container after the beverage container has been inserted into the holder. Further, the actuator may release the contact with the thermal element on removal of the beverage container from the holder. In this way, the thermal conductivity between the holder and the beverage container is maximized while minimizing the difficulty in inserting and removing the beverage container into the holder.

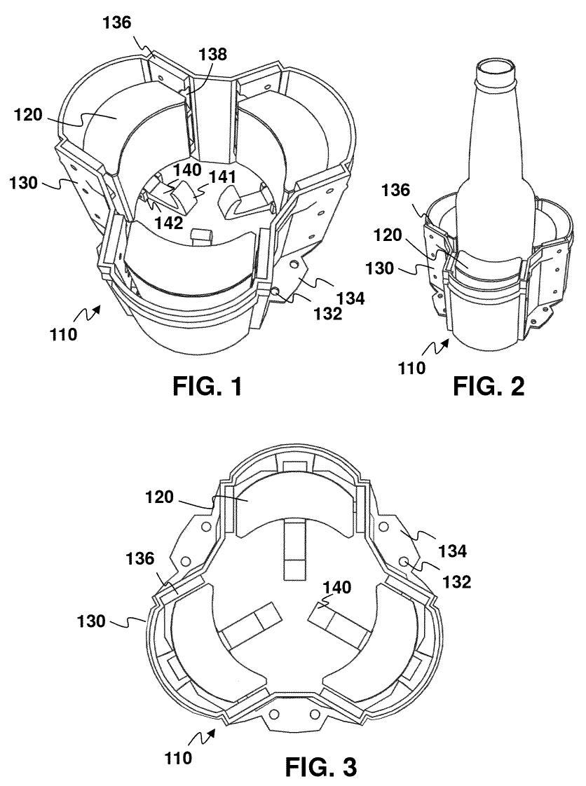

Reference is now made to FIG. 1. In FIG. 1, a beverage container holder 110 is configured with three thermal elements 120. In one embodiment, thermal elements 120 may be ice packs or hot packs. In other cases, the thermal element 120 may be an electric thermal element providing heating or cooling. In other embodiments, thermal element 120 may contain chemicals in which a reaction of the chemicals causes either heating or cooling of the element. In still further embodiments, thermal elements 120 may be conduits for dispersing heated or cooled fluid. In still a further embodiment, thermal element 120 may be fluidly connected to an external heating or cooling source. Other thermal elements 120 would be known to those skilled in the art.

While FIG. 1 shows a holder 110 having three thermal elements 120, this is not limiting and in other embodiments more or less thermal elements could be provided. For example, in some embodiments one thermal element may be sufficient. In other embodiments, four, five or more thermal elements may be provided.

Holder 110 includes a housing 130 configured to receive thermal elements 120. Housing 130 may be shaped to be received by the final application of holder 110. For example, a holder 110 may be configured for use in home embodiments such as within a recliner or chair, within a table such as a poker table, within an automobile for a beverage holder, within a picnic table, among other applications. In each case, housing 130 can be configured externally to fit within such applications.

In the example of FIG. 1, screw holes 132 within an external flange 134 may be used for mounting holder 110 into its final application. Other mounting means are however possible.

In one embodiment, housing 130 may be thermally insulated to reduce thermal loss or gain from the external ambient environment. The insulation may be incorporated within housing 130 or externally thereof, and may also extend below and/or above holder 110.

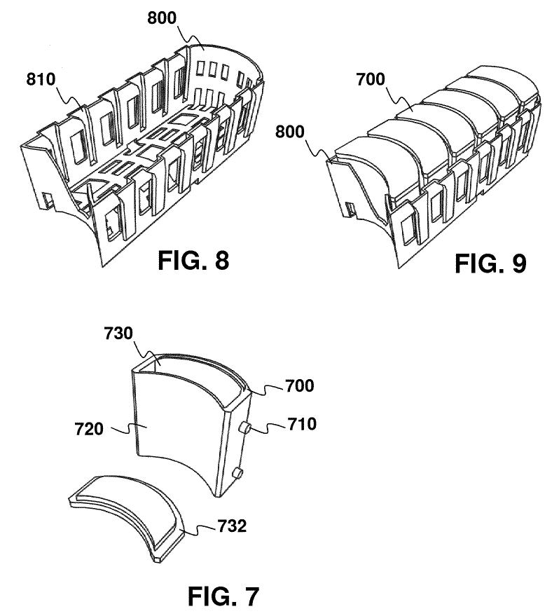

Further, holder 110 includes a supporting structure 136 configured to receive thermal element 120. For example, supporting structure 136 may include a plurality of slots 138 adapted to receive a pin on thermal element 120, for example as shown by pins 710 in FIG. 7.

In other embodiments, support structure 136 may be a cup configured to receive the thermal element 120. In this case, the support structure 136 may be comprised of thermally conductive material at least on the surface that makes contact with the beverage container. For example, a side of support structure 136 contacting a beverage container may be metal to increase thermal transfer.

Other examples of support structures 136 would be known to those in the art having regard to the present disclosure.

In accordance with the embodiment of FIG. 1, an actuation mechanism is provided which will force thermal element 120 into contact with a beverage container, for example, as shown in FIG. 2. As shown in FIGS. 1 and 3, the actuation mechanism is a mechanical actuator having an actuator arm 140.

In one embodiment, actuator arm 140 may include a raised end 141 to support a beverage container, even when the actuator arm is engaged.

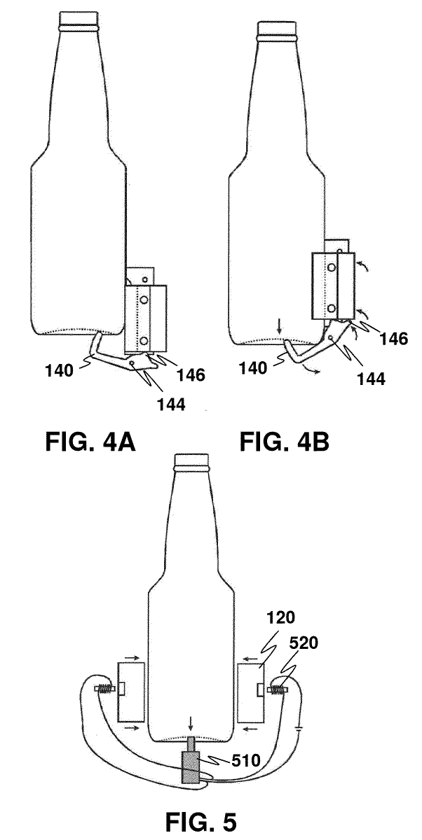

Actuator arm 140 is held by an actuator arm receiving element 142 which includes a pivot 144, as best seen in FIGS. 4A and 4B.

Further, as seen in FIGS. 4A and 4B, a flange 146 is disposed rearwardly of the pivot point 144 and is configured to limit the motion of the arm should a non-conformant beverage container be inserted Thus, referring to FIG. 4A, a beverage container is inserted and makes contact with actuator arm 140. The beverage container is then further inserted and causes actuator arm 140 to pivot about pivot point 144, thereby forcing flange 146 to move the thermal element 120 into contact with the beverage container, as seen in FIG. 4B. In one embodiment, the weight of the beverage container may be sufficient to cause the actuator arm 140 to engage.

Conversely, removal of the beverage container works in the opposite way. In particular, the pressure on actuator arm 140 is removed, thereby allowing the actuator to pivot about pivot point 144 and to release the thermal element 120 from contact with the beverage container.

The release of the thermal element 120 from the beverage container may be facilitated through various mechanisms. For example, actuator 144 may include a spring to pull the thermal element away from the beverage container. In other embodiments, support structure 136 may include a spring element to pull the thermal element 120 away from the beverage container.

Slots 134 may be upwardly sloped, thereby requiring the actuator to push the thermal element 120 up and towards the beverage container when the actuator arm 140 is engaged. In this case, the removal of the beverage container may allow gravity to pull the thermal element 120 away from the beverage container.

In other embodiments, slots 134 may be downwardly sloped, and a spring mounted bottom surface may hold the thermal elements in a disengaged position when the drink container is not present. When the drink container is present, the weight of said container would overcome the force of the springs and allow the thermal elements 120 to slide towards the container.

Other options are possible and the above is not therefore limiting.

The mechanical actuator of FIGS. 1 to 4 is not limiting. In other embodiments, other actuators can be used. For example, an electronic actuator could be provided. Reference is now made to FIG. 5, which shows one example of an electronic actuator. In FIG. 5, a switch 510 is provided as the actuator and when a beverage container makes contact with switch 510, a motor or servo 520 provides the lateral motion of thermal element 120 into or away from the beverage container. Alternative, the switch could cause a pneumatic force to push the thermal element into contact with the beverage container, or a vacuum to pull the thermal pack away from the container.

In other embodiments, instead of a switch 510, a sensor such as a heat sensor could be used to determine when a beverage container is placed within the holder 110. For example, a beverage may be cold initially and may be placed in the container. The heat sensor may sense that a cold object has been placed in proximity to the sensor and therefore actuate the thermal elements 120 into contact with the beverage container.

In other embodiments, a light sensor may be used instead of a heat sensor. In this example, when the beverage container is placed within the holder 110, light is obscured over the light sensor and this causes the actuation of the thermal element 120 into the beverage container.

In other embodiments, the switch may be external to the holder 110. Thus, for example, a button may be outside holder 110 and may be used to move thermal elements into contact or away from a beverage container. Similarly, motion sensors, heat sensors, visual sensors, among others may be outside of holder 110 and may cause the actuation of the thermal elements into contact with a beverage container.

In other embodiments, a rotational actuator could be utilized. In this case, a user may insert a beverage container into the holder 110 and provide a rotational motion in order to move the thermal elements 120 into contact with the beverage container.

Other examples of various actuators would also be known to those skilled in the art having regard to the present disclosure and the present disclosure is not meant to be limited to any particular actuator causing thermal contact between a thermal element 120 and a beverage container. Further, a combination of the mechanical, electronic, and pneumatic actuators described herein could be used.

While the above is described with regard to a thermal element being moved to make contact with a beverage container, in other embodiments, one or more of the thermal elements may be stationary, and the actuator may cause the beverage container to move towards the thermal elements, either directly or through another thermal element.

In some embodiments, holder 110 may be dimensioned to a particular type of beverage container. In this case, the diameter of the beverage container may be considered when designing the size of housing 130 as well as the design of thermal element 120. For example, a poker table application may be dimensioned for cold drinks such as beer or pop cans or bottles.

In other embodiments, the actuator mechanism may provide sufficient movement of the thermal element 120 to make contact with various sized beverage containers.

Further, in some embodiments, thermal element 120 may be adapted to rotate for conically shaped containers. Thus, in an application such as a coffee cup holder, the actuator mechanism may provide for more lateral motion of the bottom of thermal element 120 than the top of thermal element 120 in order to allow the thermal element to make better contact with a beverage container such as a coffee cup.

In yet further embodiments, the beverage container contacting surface of thermal element 120 may be soft, and thus conform to the shape of the beverage container when the actuator is engaged.

In a further embodiment, rather than having the actuator place thermal element 120 into contact with the beverage container, the actuator may provide a seal around a neck of the beverage container and provide a thermal element having fluid contact with the beverage container.

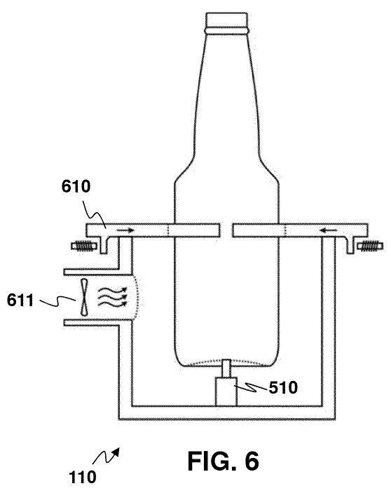

Reference is now made to FIG. 6. In the embodiment of FIG. 6, the thermal element consists of a moving fluid element such as hot or cold air which is directed to move around the beverage container by some means such as an air blower 611. The source of the fluid movement would be controlled by the actuator. Furthermore, seal 610 would be engaged by the actuator to keep the circulating fluid in contact with the beverage container, and thus prevent thermal loss. In other embodiments, liquids such as water or glycol could also be circulated around the beverage container.

In other embodiments, a seal may be engaged when a beverage container is also removed from the holder 110. This may be used, for example, to insulate thermal elements when there is no beverage container present to extend the cooling or heating life of the thermal element before the thermal element needs to be refreshed.

Holder 110 may further be equipped with other mechanisms, such as temperature sensors, which may be used, in some embodiments, to control heating or cooling of the beverage within a beverage container. Thus, for example, if a temperature is too low in a cooling application, a motor or servo may pull the thermal element away from the beverage container temporarily.

In other cases, a further beverage holder may be dimensioned to be placed within a holder 110, thereby allowing smaller beverage containers to be held.

In any of the above embodiments, indications could be provided to a user of the beverage container holder. For example, lights may indicate whether the thermal element needs to be charged, a display may provide temperate readings, audible signals may be provided when a beverage has reached an optimal temperature, among other options. The above indications are merely meant to be illustrative of various visual, audible or other signals that may be provided to a user of the beverage container holder.

Reference is now made to FIG. 7. If thermal element 120 is a hot or cold pack, one example of such a hot or cold pack is illustrated. In particular, the pack 700 may include pins 710 for engaging the support structure 132, for example as seen in FIG. 1.

Further, an outside dimension 720 may be configured for particular beverage container types.

Further, the surfaces of the pack 720 which do not contact the beverage when engaged may contain insulation

In the example of FIG. 7, pack 700 has a hollow interior 730 which may be filled with small solids such as sand, or a liquid such a glycol, for example. However, other suitable materials are known to those in the art.

A lid 732 may be provided and may be sealed at a factory once the liquid has been inserted into the interior 730.

Reference is made to FIG. 8, which shows a tray dimensioned to fit a plurality of packs 700. Further, FIG. 9 shows the tray having a plurality of packs 700 inserted therein. The tray 800 may include a channel 810 configured to accommodate pin 710, thereby allowing the pack 700 to be inserted and held into tray 800, the tray can be used to organize the packs within, for example, a freezer.

In order to prepare the packs 700 for use, the packs be placed within a freezer or within a heat source, for example such as boiling water or an oven, either individually or within tray 800.

Thus, in accordance with the above, a beverage container holder is provided in which an actuator causes a thermal element to contact the beverage container, providing greater thermal conductivity between the thermal element and the beverage container. Further, the insertion and removal of the beverage container from the beverage container holder is facilitated by the actuation of the thermal element.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A beverage container holder comprising:
a housing;
at least one thermal element configured to fit within the housing; and
an actuator configured to cause thermal contact between the at least one thermal element and a beverage container.

2. The beverage container holder of claim 1, wherein the actuator is a mechanic actuator.

3. The beverage container holder of claim 2, wherein the mechanical actuator comprises an actuator arm on a pivot, wherein a flange on one end of the actuator arm causes the thermal element to cause thermal contact with the beverage container when the beverage container makes contact with an opposite end of the actuator arm.

4. The beverage container holder of claim 3, wherein the actuator arm comprises a raised portion at the opposite end of the actuator arm.

5. The beverage container holder of claim 1, wherein the actuator is an electronic switch controlling a motor or servo to cause the at least one thermal element to move into thermal contact with the beverage container.

6. The beverage container holder of claim 1, wherein the actuator is a sensor internal to the housing to cause the at least one thermal element to make thermal contact with the beverage container.

7. The beverage container holder of claim 1, wherein the actuator is a sensor external to the housing to cause the at least one thermal element to move into thermal contact with the beverage container.

8. The beverage container holder of claim 1, wherein the actuator is a rotational actuator, wherein rotation of the beverage container while the beverage container is within the housing causes the at least one thermal element to move into thermal contact with the beverage container.

9. The beverage container holder of claim 1, wherein the at least one thermal element is a hot or cold pack.

10. The beverage container holder of claim 9, wherein the hot or cold pack includes a pin configured to engage a channel within the housing of the beverage container holder for lateral movement of the hot or cold pack.

11. The beverage container holder of claim 9, wherein the hot or cold pack is configured to fit within a moveable cup within the housing.

12. The beverage container holder of claim 11, wherein the cup includes at least one thermally conductive surface.

13. The beverage container holder of claim 1, wherein the at least one thermal element is an electronic heating or refrigeration unit.

14. The beverage container holder of claim 1, wherein the at least one thermal element is in fluid communication with an external heating or refrigeration source.

15. The beverage container holder of claim 1, wherein the actuator is configured to cause a seal to close over a portion of the beverage container.

16. The beverage container holder of claim 15, wherein the at least one thermal element is a fluid discharge outlet.

17. The beverage container holder of claim 1, further comprising insulation around the housing.

18. The beverage container holder of claim 1, wherein the actuator is further configured to cause an insulating layer to be placed over the housing when the beverage container is removed.

19. The beverage container holder of claim 1, wherein the actuator causes the beverage container to move into contact with a stationary thermal element.

20. The beverage container holder of claim 1, wherein the actuator controls at least one of a mechanical means, magnetic motor, electromagnet, and pneumatic means to create thermal contact between the thermal element and beverage container.

21. The beverage container holder of claim 9, wherein the thermal element moves to come in contact with a secondary thermal source when the beverage container is not present.

22. The beverage container holder of claim 1, further including an external display indicating a thermal state of the beverage container within the holder.

23. The beverage container holder of claim 1, further including an audio indication of the thermal state of the beverage container within the holder.

24. The beverage container holder of claim 1, wherein the actuator may engage or disengage the thermal elements based on a sensed thermal state of the beverage container within the holder.

25. The beverage container holder of claim 9, further including an external display indicating a state of the thermal elements within the holder.
